(19) United States
(12) Patent Application Publication
(10) Pub. No.: US 2014/0378083 A1
(43) Pub. Date: Dec. 25, 2014

(54) Device Sensor Mode to Identify a User State

(71) Applicant: Plantronics, Inc., Santa Cruz, CA (US)

(72) Inventors: Ken Kannappan, Palo Alto, CA (US); Douglas Rosener, Santa Cruz, CA (US)

(21) Appl. No.: 13/926,903

(22) Filed: Jun. 25, 2013

(51) Int. Cl. H04W 76/00; H04W 76/02

(52) U.S. Cl. CPC H04W 76/007; H04W 76/02
USPC 455/404.1; 455/414.1

(57) ABSTRACT

Methods and apparatuses for user state detection are disclosed. In one example, a body worn device microphone is enabled to receive sound to determine a user state. The method includes receiving a sound signal from the body worn device microphone. The method further includes identifying a user state from the sound signal.

### BACKGROUND OF THE INVENTION

It is often desirable to know the current status of a person. For example, it is desirable to know when a person is available for a conversation and whether the person is available to receive an incoming communication such as a phone call or a text message. It is also desirable to know whether a person is in an emergency state where a necessary action must be promptly taken.

In the past, people typically used a landline phone as their primary or only means of receiving communications. If a person was on a call, a second incoming call was sent to voicemail or resulted in a busy signal. If the person was not near their phone, then any incoming calls went unanswered and/or were forwarded to voicemail.

In the modern communications environment, people utilize a variety of devices to communicate and can receive incoming communications on any of these devices. For example, a typical person may be able to receive mobile phone calls and VoIP telephone calls in addition to calls to their landline public switched telephone network (PSTN) telephone. In addition, the person may receive text based messages such as instant messages at one or more of these devices. The person may receive incoming communications on one communication device while conducting communications with another device. Furthermore, mobile devices such as smartphones allow a person to receive communications at virtually any location, thereby increasing the complexity of whether a person is available to receive incoming communications.

As a result, improved methods and apparatuses for determining a person's status are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a conversation detection system for determining a headset user availability to receive an incoming communication in one example.

FIG. 2 illustrates a conversation detection system for determining a headset user availability to receive an incoming communication in a further example.

FIG. 3 illustrates a first example conversation scenario in which the conversation detection system shown in FIG. 1 is utilized.

FIG. 4 illustrates a second example conversation scenario in which the conversation detection system shown in FIG. 1 is utilized.

FIG. 5 an example conversation scenario in which the conversation detection system shown in FIG. 2 is utilized.

FIG. 6 illustrates an example implementation of the conversation detection system shown in FIG. 1.

FIG. 7 illustrates an example implementation of the conversation detection system shown in FIG. 1 and FIG. 6.

FIG. 8 illustrates a further example implementation of the conversation detection system shown in FIG. 1 and FIG. 6.

FIG. 9 illustrates a further example implementation of the conversation detection system shown in FIG. 1 and FIG. 6.

FIG. 10 illustrates an example implementation of the conversation detection system shown in FIG. 2.

FIG. 11A is a table illustrating availability rules in one example for determining a headset user availability to receive incoming communications based on conversation detection.

FIG. 11B is a table illustrating availability rules in a further example for determining a headset user availability to receive incoming communications based on conversation detection.

FIG. 11C is a table illustrating availability rules in a further example for determining a headset user availability to receive incoming communications based on conversation detection.

FIG. 12 illustrates a headset in one example configured to implement one or more of the examples described herein.

FIG. 13 is a flow diagram illustrating a method for conversation detection at a headset to determine a headset user availability to receive an incoming communication in one example.

FIG. 14 is a flow diagram illustrating a method for conversation detection at a headset to determine a headset user availability to receive an incoming communication in one example.

FIG. 15 is a flow diagram illustrating a method for determining a user status in one example.

### DESCRIPTION OF SPECIFIC EMBODIMENTS

Methods and apparatuses for determining user states are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein.

Block diagrams of example systems are illustrated and described for purposes of explanation. The functionality that is described as being performed by a single system component may be performed by multiple components. Similarly, a single component may be configured to perform functionality that is described as being performed by multiple components. For purpose of clarity, details relating to technical material that is known in the technical fields related to the invention have not been described in detail so as not to unnecessarily obscure the present invention. It is to be understood that various example of the invention, although different, are not necessarily mutually exclusive. Thus, a particular feature, characteristic, or structure described in one example embodiment may be included within other embodiments unless otherwise noted.

The inventor has recognized that a body worn device having a microphone can be used as a sensor to detect a current user state based on sound detected at the microphone. For example, a headset may be operated in a sensor mode when the headset is not being used in a telecommunications mode to conduct a call. Although other body worn devices or devices may be used, a headset is particularly advantageous because users can easily continue to wear their headset and often do so regardless of whether they are using the headset to conduct a call. As such, the headset is already often in place to operate in a sensor mode. Furthermore, the headset is in a position optimized to detect a wearer's voice during operation in sensor mode. In a further example, the headset is operated in the sensor mode when not being worn by the user, whereby the headset is in a proximity to the user close enough to detect user conversation.

In one example usage, the inventor has recognized that when a person is outside his office in a meeting room, collaborative work area, or public space, there may be an increased likelihood he is in a face-to-face conversation (i.e., offline or not using electronic communications) with other people. Since the person may receive incoming communications wherever his location, the inventor has recognized the need to gather and utilize information about these face-to-face conversations in determining the person's availability to receive incoming communications.

In one example of the invention, a method includes entering a sensor mode at a body worn device, where during the sensor mode a body worn device microphone is enabled to receive sound independent of whether the body worn device is participating in a voice call. A sound signal is received from the body worn device microphone while the body worn device is in the sensor mode. The method includes identifying a conversation from the sound signal, and determining from the conversation a body worn device user availability to receive an incoming communication.

In one example, a method includes entering a sensor mode at a body worn device. During the sensor mode, a body worn device microphone is enabled to receive sound to determine a user state. The method includes receiving a sound signal from the body worn device microphone while the body worn device is in the sensor mode. The method further includes identifying a user state from the sound signal.

In one example, a method includes entering a sensor mode at a body worn device, wherein during the sensor mode a body worn device microphone is enabled to receive sound independent of whether the body worn device is participating in a telecommunications call. The method includes receiving a sound signal from the body worn device microphone while the body worn device is in the sensor mode. The method further includes identifying a body worn device user state from the sound signal.

In one example, a method for operating a body worn device includes receiving a first sound signal from a first body worn device microphone while a first body worn device associated with a first body worn device user is operating in a sensor mode, wherein during the sensor mode the first body worn device microphone is enabled to receive sound independent of whether the first body worn device is participating in a telecommunications call. The method includes receiving a second sound signal from a second body worn device microphone while a second body worn device associated with a second body worn device user is operating in a sensor mode, wherein during the sensor mode the second body worn device microphone is enabled to receive sound independent of whether the second body worn device is participating in a telecommunications call. The method further includes identifying a conversation between the first body worn device user and the second body worn device user from the first sound signal and the second sound signal. The method further includes determining from the conversation a first body worn device user availability to receive an incoming communication and a second body worn device user availability to receive an incoming communication.

In one example, a body worn device includes a processor, a communications interface, a speaker arranged to output audible sound to a body worn device wearer ear, and a microphone arranged to detect sound and output a sound signal. The body worn device includes a memory storing an application executable by the processor configured to operate the body worn device in a sensor mode to process the sound signal and identify a body worn device user participation in a conversation, wherein during the sensor mode the microphone is enabled to detect sound independent of whether the body worn device is participating in a telecommunications call.

In one example, one or more non-transitory computer-readable storage media have computer-executable instructions stored thereon which, when executed by one or more computers, cause the one more computers to perform operations including receiving a sound signal from the body worn device microphone while the body worn device is in a sensor mode, where during the sensor mode a body worn device microphone is enabled to receive sound independent of whether the body worn device is participating in a telecommunications call. The operations include identifying a conversation from the sound signal, and determining from the conversation a body worn device user availability to receive an incoming communication.

In one example, one or more non-transitory computer-readable storage media have computer-executable instructions stored thereon which, when executed by one or more computers, cause the one more computers to perform operations comprising including receiving a first sound signal from a first body worn device microphone at a first body worn device associated with a first body worn device user. The operations include receiving a second sound signal from a second body worn device microphone at a second body worn device associated with a second body worn device user, and identifying a conversation between the first body worn device user and the second body worn device user from the first sound signal and the second sound signal. The operations further include determining from the conversation a first body worn device user availability to receive an incoming communication and a second body worn device user availability to receive an incoming communication.

In one example, a method includes receiving a sound signal from a body worn device microphone while a body worn device speaker is in a low-power or powered-off state, and identifying a conversation from the sound signal. The method further includes determining from the conversation a body worn device user availability to receive an incoming communication.

In one example, one or more non-transitory computer-readable storage media have computer-executable instructions stored thereon which, when executed by one or more computers, cause the one more computers to perform operations including receiving a sound signal from a body worn device microphone while a body worn device speaker is in a low-power or powered-off state. The operations include identifying a conversation from the sound signal, and determining from the conversation a body worn device user availability to receive an incoming communication.

In one example, a headset includes a processor, a communications interface, a speaker arranged to output audible sound to a headset wearer ear, and a microphone arranged to detect sound and output a sound signal. The headset includes a memory storing an application executable by the processor configured to process the sound signal and identify a headset user participation in a conversation while the speaker is in a powered-off state or a low-power state.

In one example, a microphone is kept “open” on a headset, even when not engaged in a call using the headset. The microphone detects the user's voice as an activity detection. Furthermore, it not only detects that the user's voice is active, it also detects background voices as well. By suitably processing the voices and pauses, it is detected whether there is an exchange going between the voices, as opposed to the voices just occurring randomly. If the user is engaged in a conversation, even if not actively on a call as detected by the headset, this information can be relayed via the headset data communications link to a suitable presence provider to indicate the user is busy. If multiple participants in a conversation have the same headset with the voice sensing capability, one can improve the accuracy of the conversation detector as well by capturing information from all headsets and indicate for the organization at large that these users are participants in the same informal conversation.

In this manner, accuracy is determining a user availability to receive an incoming communication is improved. A face-to-face conversation can be detected and a relative importance be assigned based on the identities of the participants. Based on the relative importance, the user availability to be interrupted can be determined or escalation rules can be applied. The face-to-face conversation data can be used in conjunction with heatmap tools that identify who is talking to whom, and who is emailing whom, on systems that capture meetings data, email data, and communications systems call data.

In one example, the sound detected by the microphone while the headset is in sensor mode is processed to determine whether the user is in an emergency state. For example, the emergency state is identified by recognizing a spoken emergency word in the sound signal (e.g. “help”) or identified by recognizing a sound pattern associated with an emergency in the sound signal (e.g., sound patterns indicative that the user is having a heart attack or is in pain). In one example, the sound is processed locally to identify the emergency state. In a further example, the sound is transmitted to a remote device (e.g., over a network to a server) for processing to identify the emergency state.

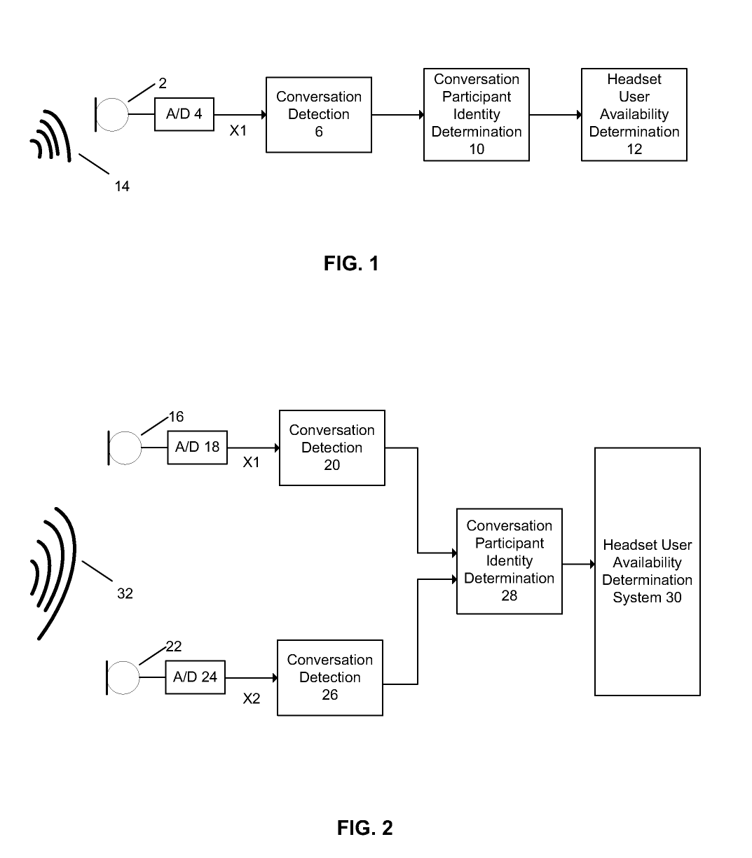

FIG. 1 illustrates a conversation detection system for determining a device user availability to receive an incoming communication in one example. The conversation detection system may be a distributed system. Components of the conversation detection system may be implemented on a single host device or across several devices, including cloud based implementations. The conversation detection system includes a microphone 2 disposed at a body worn device (e.g., a headset), analog-to-digital (A/D) converter 4, conversation detection system 6, conversation participant identity determination system 10, and body worn device (e.g., headset) user availability determination system 12. Although only a single microphone 2 is illustrated, in a further example an array of two or more microphones may be used. The output of microphone 2 is coupled to analog-to-digital converter 4, which outputs a digital sound signal X1 to conversation detection system 6.

In the example shown in FIG. 1, microphone 2 detects sound 14 from one or more external sound sources in the vicinity of microphone 2. The analog signal output from microphone 2 is input to A/D converter 4 to form the digital sound signal X1. Digital sound signal X1 may include several signal components, including speech of a headset user, speech of a conversation participant in conversation with the headset user, speech from other people in the vicinity of microphone 2, and background noise. Signal X1 is input to conversation detection system 6 for processing.

Conversation detection system 6 processes signal X1 to determine whether a conversation is detected. In one example, signal X1 is processed to determine whether it contains alternating voices (i.e., turn-taking indicative of conversation) with a threshold level of continuity (i.e., not too many pauses), thereby indicating a detected conversation. Conversation participant identity determination system 10 processes signal X1 to determine whether the headset user is a participant in the conversation. In one example implementation, conversation participant identity determination system 10 determines whether the headset user is a participant by determining a sound level from the sound signal X1 indicating the headset is being worn by the user and the headset user is speaking. In this situation, the sound level of the headset user's voice will be higher than any other detected voice due to the proximity of the headset microphone to the user mouth. In one example, the headset is associated with the identity (i.e., name) of a particular headset user. Similarly, other headsets in the system are associated with the identities of other users. In one example, to use the headset, the user must enter a password or otherwise validate his identity.

As previously mentioned, in one example conversation participant identity determination system 10 determines whether the headset user is a participant by determining a sound level from the sound signal X1 indicating the headset is being worn by the user and the headset user is speaking. In one example, a threshold level is utilized from the design of the system and/or empirically. In one example, the microphone system is designed to offer on the order of 10 dB threshold of discrimination (i.e., the average sound level for the speaker will always be an order of magnitude at least 10 dB above a conversational partner).

In one example, the microphone assembly is optimized to discriminate between speaker and conversational partner by using two effects (1) a boom near the mouth has higher output for the speaker due to pressure level difference and proximity effect, and (2) directional microphone assemblies can increase the pressure level for the speaker. By averaging the level at low frequencies, using a microphone near the mouth, and using directional microphones, discrimination between speaker and conversational partner based on sound level is better obtained.

For example, conversational speech level due to the speaker at 1 inch in front of the speaker mouth is standardized at about 89 dBSPL, which may vary depending on the actual speaker. This may drop 10 to 15 dB depending on the microphone placement (boom near mouth, or microphone near ear), being a level approximately as low as 74 dBSPL at the ear. There is an added boost to the speaker level at low frequencies (at least 6 dB and sometimes as much as 20 dB) due to the proximity effect, which is due to the non-plane-wave nature of the speaker versus the plane-wave of the conversational partner. Therefore the closer the boom is to the speaker mouth, the better.

The level due to a person 1 meter away at standardized speech level is 76 dBSPL. Note that a person at 2 M will be 12 dB down from this, or 64 dBSPL. Thus, a boom microphone near the mouth discriminates between speaker and speaking partner on the order of 13 dB. If the boom is very short, this is reduced if the partner is 1 meter away, and further discrimination based on the directionality of the microphone assembly is utilized. A partner 2 meters away or more is easily discriminated in most cases. Generally, up to 6 dB is obtained from the directionality of the microphone.

In one example implementation, headset user availability determination system 12 determines whether the headset user is available to receive an incoming communication based on whether the headset user is a participant in the conversation. For example, the incoming communication may be a real-time communication. Without limitation, the incoming communication may be an incoming voice call such as a mobile or VoIP call or a text based message such as an instant message. Although shown as separate blocks, the functionality performed by conversation detection system 6 and conversation participant identity determination system 10 may be integrated into a single functional system.

In one example implementation, conversation participant identity determination system 10 further determines an identity of a second conversation participant in conversation with the headset user. For example, voice recognition may be utilized. In this implementation, headset user availability determination system 12 determines whether the headset user is available to receive an incoming communication based on the identity of the second conversation participant.

In one example, the conversation detection system is operated while the headset is in a sensor mode. During the sensor mode, the headset microphone is enabled to receive sound to determine the headset user state. In one example, the headset is operated in sensor mode whenever the headset is not being used on a call and the headset user activates the sensor mode. When the headset is being used on a call, the headset is operated in a communications mode where the headset microphone is enabled to receive sound to transmit to a far end caller via a phone device such as a mobile phone.

FIG. 2 illustrates a conversation detection system for determining a headset user availability to receive an incoming communication in a further example. The conversation detection system may be a distributed system. Components of the conversation detection system may be implemented across several devices, including cloud based implementations. The system includes a microphone 16 disposed at a first body worn device (e.g., a first headset), analog-to-digital (A/D) converter 18, and conversation detection system 20. The output of microphone 16 is coupled to the analog-to-digital converter 18, which outputs a digital sound signal X1 to conversation detection system 20. Although only a single microphone 16 is illustrated, in a further example an array of two or more microphones may be used.

The system includes a microphone 22 disposed at a second body worn device (e.g., a second headset), analog-to-digital (A/D) converter 24, and conversation detection system 26. The output of microphone 22 is coupled to the analog-to-digital converter 24, which outputs a digital sound signal X2 to conversation detection system 26. Although only a single microphone 22 is illustrated, in a further example an array of two or more microphones may be used.

The system further includes a conversation participant identity determination system 28 and headset user availability determination system 30. Conversation participant identity determination system 28 receives input from conversation detection system 20 and conversation detection system 26 and provides an output to headset user availability determination system 30.

In the example shown in FIG. 2, microphone 16 detects sound 32 from one or more external sound sources in the vicinity of microphone 16. The analog signal output from microphone 16 is input to A/D converter 18 to form a digital sound signal X1. Digital sound signal X1 may include several signal components, including speech of a first headset user, speech of a second headset user, speech of a conversation participant in conversation with the first headset user, speech from other people in the vicinity of microphone 16, and background noise. Signal X1 is input to conversation detection system 20 for processing. Conversation detection system 20 processes signal X1 to determine whether a conversation is detected.

Similarly, microphone 22 also detects sound 32 from one or more external sound sources in the vicinity of microphone 22. The analog signal output from microphone 22 is input to A/D converter 24 to form a digital sound signal X2. Digital sound signal X2 may include several signal components, including speech of a first headset user, speech of a second headset user, speech of a conversation participant in conversation with the second headset user, speech from other people in the vicinity of microphone 22, and background noise. If microphone 22 is in the same general vicinity of microphone 16, signal X1 and signal X2 will have substantially similar signal components. However, because of the different spatial location relative to any sound sources, the corresponding signal components of the sound sources will have different weighting in signal X1 and signal X2. Signal X2 is input to conversation detection system 26 for processing. Conversation detection system 26 processes signal X2 to determine whether a conversation is detected using techniques described herein.

Conversation participant identity determination system 28 processes signal X1 and signal X2 to determine whether the first headset user and the second headset user are in conversation with each other. In one example implementation, conversation participant identity determination system 28 determines whether the first headset user and the second headset user are in conversation with each other by comparing the first sound signal X1 to the second sound signal X2. In one embodiment, conversation participant identity determination system 28 includes a speech recognition system operable to recognize a first headset user speech content and a second headset user speech content in the first sound signal X1, and recognize the first headset user speech content and the second headset user speech content in the second sound signal X2. The first headset user speech content and the second headset user speech are utilized in identifying the conversation between the first headset user and the second headset user. In a further embodiment, conversation participant identity determination system 28 includes a voice pattern recognition system operable to recognize a first headset user voice and recognize a second headset user voice utilizing stored voice patterns of the first headset user and the second headset user. Using the voice pattern recognition system, the conversation participant identity determination system 28 recognizes the first headset user's voice and the second headset user's voice in signal X1. The conversation participant identity determination system 28 also recognizes the second headset user's voice and the first headset user's voice in signal X2 to identify that the first headset user and the second headset user are in conversation with each other.

In one example implementation, headset user availability determination system 30 determines whether the first headset user is available to receive an incoming communication based on whether the first headset user is a participant in the conversation and the identity of the second headset user in conversation with the first headset user. In a further example, the first headset user availability is also dependent on the identity of the originator of the incoming communication in addition to the identity of the second headset user.

In one example implementation, headset user availability determination system 30 determines whether the second headset user is available to receive an incoming communication based on whether the second headset user is a participant in the conversation and the identity of the first headset user in conversation with the second headset user. In a further example, the second headset user availability is also dependent on the identity of the originator of the incoming communication in addition to the identity of the first headset user. In one example, the conversation detection system shown in FIG. 2 is operated while the first headset is operated in the sensor mode and the second headset is operated in the sensor mode.

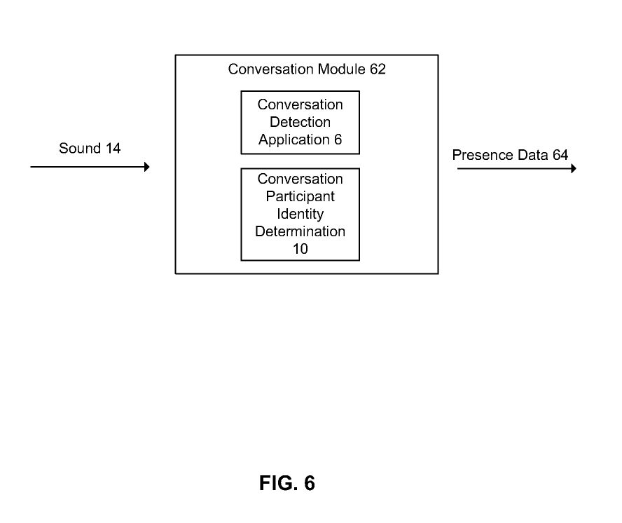

FIG. 6 illustrates an example implementation of the conversation detection system 6 and conversation participant identity determination system 10 shown in FIG. 1. The conversation detection system 6 and conversation participant identity determination system 10 are implemented at a conversation module 62. Conversation module 62 receives sound 14 and processes sound 14 using conversation detection system 6 and conversation participant identity determination system 10. Based on the results of this processing, conversation module 62 outputs presence data 64. Presence data 64 includes whether the headset user is participating in a conversation and may include the identity of the other conversation participant.

In one example, conversation module 62 includes a signal level detector interfacing with or integrated with conversation detection system 6 and/or conversation participant identity determination system 10 to implement the processes and functionality described herein. The signal level detector is operable to detect a signal level of signal X1.

In one example, conversation module 62 includes a speech recognition module interfacing with or integrated with conversation detection system 6 and/or conversation participant identity determination system 10 to implement the processes and functionality described herein. The speech recognition module is operable to recognize words in a microphone output signal, such as in signal X1.

In a further example, conversation module 62 includes a voice recognition module capable of biometric voice matching interfacing with or integrated with conversation detection system 6 and/or conversation participant identity determination system 10 to implement the processes and functionality described herein. The voice recognition module is operable to detect the identity of the person speaking in the signal X1 using a previous voice sample of the speaker for comparison.

In one example, conversation module 62 is implemented on a headset. In a further example, conversation module 62 may be implemented on a variety of mobile devices designed to be worn on the body or carried by a user. Conversation module 62 may be a distributed system. Components of conversation module 62 may be implemented on a single host device or across several devices, including cloud based implementations. Example devices include headsets, mobile phones, personal computers, and network servers.

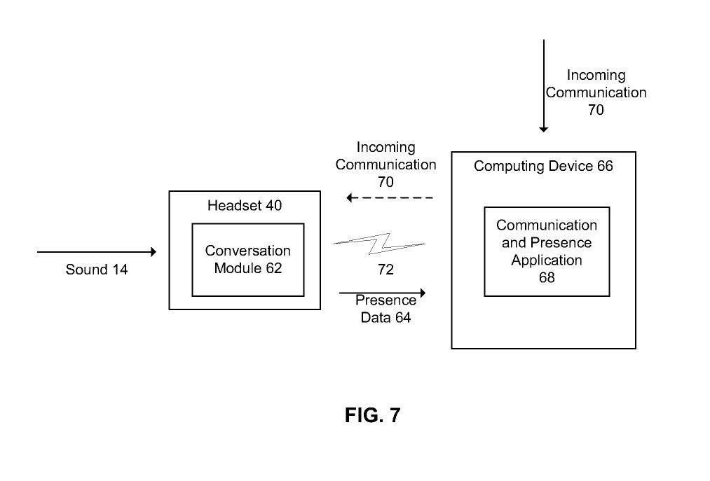

FIG. 7 illustrates an example implementation of the conversation detection system shown in FIG. 1 and FIG. 6. In this implementation, the conversation detection system is shown is used in a presence and communication system. While the term “presence” has various meanings and connotations, the term “presence” is used in the following examples to refer to a user's willingness, availability and/or unavailability to participate in communications and/or means by which the user is currently capable or incapable of engaging in communications. The term presence data (also referred to herein as “presence information”) may also refer to the underlying user state (e.g., conversation state), device usage characteristics or proximity location used to derive a user's willingness, availability and/or unavailability to participate in communications such as real time communications and/or means by which the user is currently capable or incapable of engaging in communications.

In one example, a headset 40 includes one or more sensors such as capacitive sensors to determine whether headset 40 is donned or doffed. The headset usage state of whether the headset is donned or doffed may be utilized in conjunction with the detected conversation state to determine the headset user availability to participate in communications. For example, if it is determined the headset 40 is donned because the capacitive sensor detects contact with the user skin, then the headset microphone is known to be in an optimized position to detect whether the headset user is participating in a conversation and the detected voice level will be high. Further discussion regarding the use of sensors or detectors to detect a donned or doffed state can be found in the commonly assigned and co-pending U.S. patent application entitled “Donned and Doffed Headset State Detection” (Attorney Docket No.: 01-7308), which was filed on Oct. 2, 2006, and which is hereby incorporated into this disclosure by reference. Presence data may also include the current location of the headset, whereby the user may be unavailable or available based on an identified headset location.

Conversation module 62 is disposed at a headset 40. Headset 40 is connectible to a computing device 66 having a communication and presence application 68 via a communications link 72. Although shown as a wireless link, communications link 72 may be a wired or wireless link. For example, computing device 66 may be a personal computer, notebook computer, or smartphone. Conversation module 62 receives and processes sound 14, and outputs presence data 64 as described herein.

Communication and presence application 68 receives presence data 64 from headset 40. This presence data 64 is processed and stored. For example, the presence data 64 received may be in the form of detected conversation data which is further processed to generate additional presence information. In this example, communication and presence application 68 performs the previously described functions of headset user availability determination system 12. Communication and presence application 68 determines the availability of the user of headset 40 to receive an incoming communication 70 received by computing device 66 based on presence data 64. If communication and presence application 68 determines that the user of headset 40 is available to receive incoming communication 70, communication and presence application 68 transmits incoming communication 70 to headset 40 or, alternatively depending upon the incoming communication 70 type, outputs incoming communication 70 at computing device 66.

In one example implementation, the communication and presence application 68 receives and processes presence information from one or more wireless devices, including presence data 64 from headset 40. The communication and presence application 68 includes a presence monitoring program adapted to receive and process presence data 64 associated with conversations detected at headset 40, and a communications program for receiving, processing, and routing incoming communications 70 based on the presence data 64.

In one example, the communication and presence application 68 receives detected conversation characteristics at one or more wireless headsets or telephones. For each wireless headset or telephone, the presence monitoring program stores the detected conversation characteristics information in an updatable record. The communication and presence application 68 uses the updatable record to generate presence information about a user. This presence information includes the headset 40 user's willingness and availability to receive incoming communications 70. This generated presence information is used by the communications program to route incoming communications 70.

In one example, the computing device 66 with communication and presence application 68 operates as a “presence server”. The presence server is configured to store an updatable record of the conversation state detected at headset 40. In addition to detected conversation characteristics, the presence server may receive usage and proximity information associated with headset 40 and stores this information in the updatable record. For example, such usage and proximity information may include, but are not limited to whether headset 40 is donned or doffed, is in a charging station, or is being carried but not worn. Proximity information may be related to a proximity between headset 40 and a near end user, related to the proximity between the headset 40 to the computing device 66, or related to the proximity between headset 40 to one or more known locations. In one example, proximity information is determined by measuring strengths of signals received by headset 40. Additional presence information may be derived or generated from detected usage characteristics and proximity information. This additional presence information commonly assigned and co-pending U.S. patent application entitled “Headset-Derived Real-Time Presence and Communication Systems and Methods” (Attorney Docket No.: 01-7366), application Ser. No. 11/697,087, which was filed on Apr. 5, 2007, and which is hereby incorporated into this disclosure by reference for all purposes.

The communication and presence application 68 described in FIG. 7 may be implemented as a standalone computer program configured to execute on computing device 66. In an alternative embodiment, the communication and presence application is adapted to operate as a client program, which communicates with communication and presence servers configured in a client-server network environment.

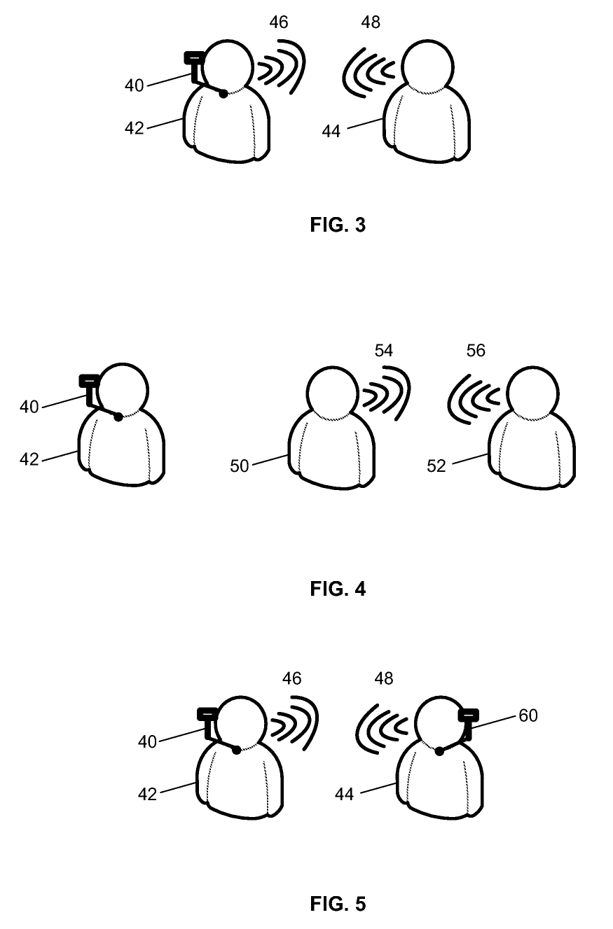

FIG. 3 illustrates a first example conversation scenario in which the conversation detection system shown in FIG. 7 is utilized. In the example shown in FIG. 3, a headset user 42 is wearing a headset 40. Headset user 42 is in conversation with a conversation participant 44. Headset 40 detects sound 14, which in this scenario includes speech 46 from headset user 42 and speech 48 from conversation participant 44. The headset 40 utilizing conversation module 62 determines that headset user 42 is currently participating in a conversation. Headset 40 may also determine the identity of conversation participant 44.

FIG. 4 illustrates a second example conversation scenario in which the conversation detection system shown in FIG. 7 is utilized. In the example shown in FIG. 4, a headset user 42 is wearing a headset 40. A conversation participant 50 is in conversation with a conversation participant 52 in the vicinity of headset user 42. Headset 40 detects sound 14, which in this scenario includes speech 54 from participant 50 and sound 56 from conversation participant 52. The headset 40 utilizing conversation module 62 determines that headset user 42 is not currently participating in a conversation.

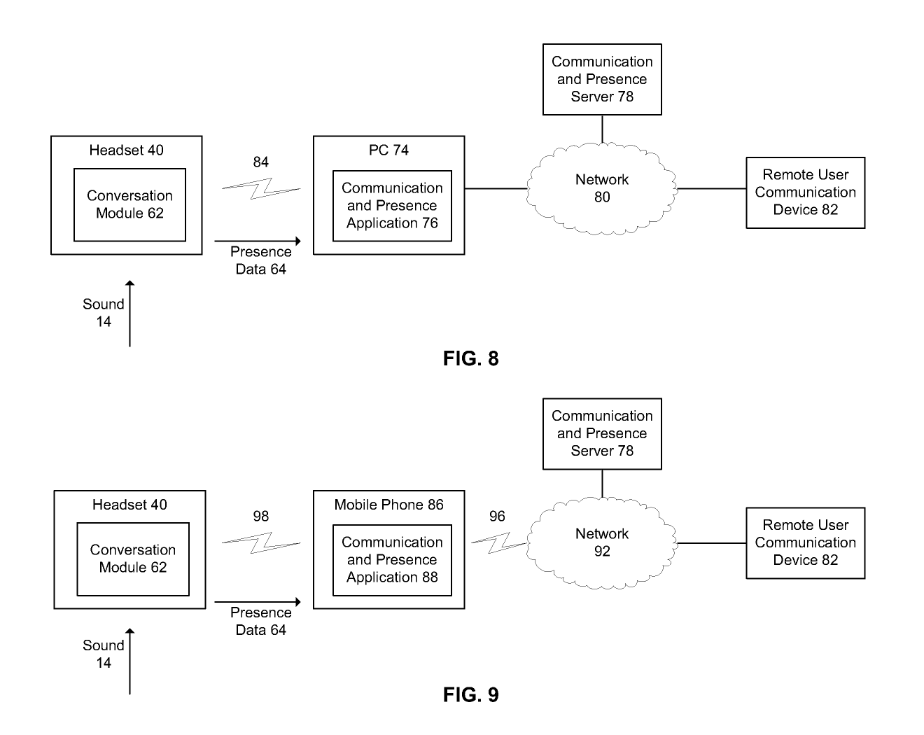

FIG. 8 illustrates a further example implementation of the conversation detection system shown in FIG. 1. FIG. 8 shows an exemplary client-server-based headset-derived presence and communication system, according to an embodiment of the present invention. The system includes a communication and presence server 78, a communication and presence application client 76 installed on a client computer (e.g., personal computer 74), and a headset 40 having a conversation module 62 installed thereon. In operation, headset 40 receives sound 14 and transmits presence data 64 to personal computer 74. Conversation module 62 at headset 40 receives and process sound 14 as described herein.

The personal computer 74 is configured to receive detected conversation characteristics (e.g., presence data 64) over a wireless (as shown) or wireless link 84. The communication and presence application client 76 communicates the presence data 64 to communication and presence server 78 over network 80. For example, network 80 may be an Internet Protocol (IP) network. Communication and presence server 78 is configured to store an updatable record of the detected conversation state at headset 40. Communication and presence server 78 is also configured to store updatable records of the detected conversation state at additional headsets or mobile devices associated with other users.

The communication and presence server 78 is operable to signal the communication and presence application client 76 on the PC 74 that a communication (e.g., an IM or VoIP call) has been received from a remote user communication device 82 (e.g., a remote computer or mobile phone). The communication and presence application client 76 can respond to this signal in a number of ways, depending on which one of the detected conversation states the headset 40 is in.

In one example, the communication and presence server 78 uses the detected conversation state record to generate and report presence information of the user of headset 40 to other system users, for example to a user stationed at the remote communication device 82. The user stationed at the remote communication device can view the availability of the user of headset 40 prior to sending or initiating any communication.

FIG. 9 illustrates a further example implementation of the conversation detection system shown in FIG. 1. In this implementation, conversation module 62 is an application disposed at and executable on a headset 40 in communication with a mobile phone 86 via a communications link 98, which may be a wired or wireless communications link. Mobile phone 86 executes a communication and presence application client 88 and is connectible to a communication and presence server 78 via a network 92. For example, network 92 may be a cellular communications network. Mobile phone 86 may, for example, be a smartphone. The system shown in FIG. 9 functions in a similar manner to that of the system shown in FIG. 8.

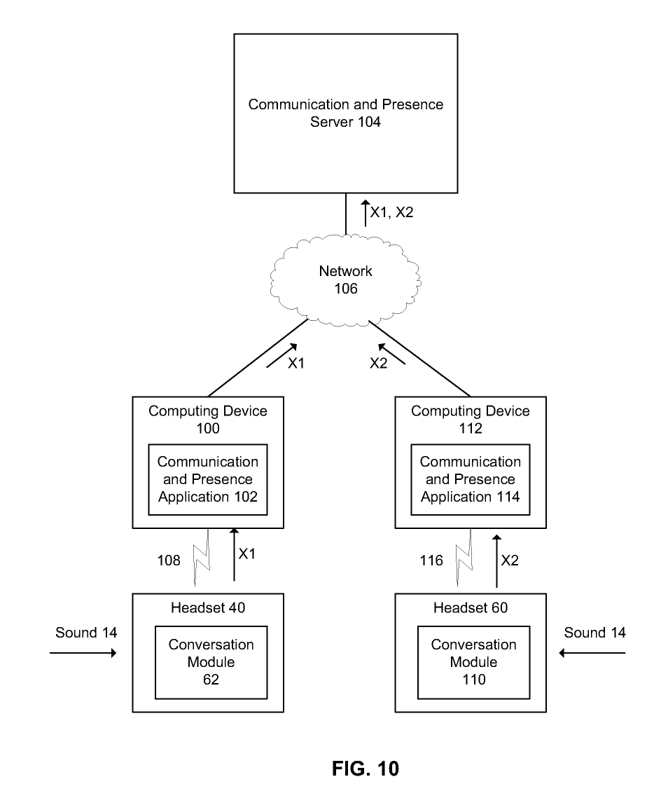

FIG. 10 illustrates an example implementation of the conversation detection system shown in FIG. 2 in an exemplary client-server-based headset-derived presence and communication system. The system includes a communication and presence server 104, a communication and presence application client 102 installed on a client computing device 100, a headset 40 having a conversation module 62 installed thereon, a communication and presence application client 114 installed on a computing device 112, and a headset 60 having a conversation module 110 installed thereon. In this example, communication and presence server 104 performs the previously described functions of the conversation participant identity determination system 28 and headset user availability determination module 30. In one example, timestamp (i.e., date and time) data for signal X1 and signal X2 is captured and transmitted to communication and presence server 104. The timestamp data is utilized in the conversation detection process described below to prevent false or null detections of conversations that are not time synchronous.

In operation, headset 40 receives sound 14 and outputs digital sound signal X1 to computing device 100 via communication link 108. Conversation module 62 at headset 40 receives and process sound 14 as described herein. Computing device 100 relays sound signal X1 to communication and presence server 104 via network 106. Headset 60 receives sound 14 and outputs digital sound signal X2 to computing device 112 via communication link 116. Conversation module 110 at headset 60 receives and process sound 14 as described herein. Computing device 112 relays sound signal X2 to communication and presence server 104 via network 106.

Communication and presence server 104 processes the received signal X1 and signal X2 to determine whether the first headset user (e.g., user of headset 40) and the second headset user (e.g., user of headset 60) are in conversation with each other. In one example implementation, communication and presence server 104 determines whether the first headset user and the second headset user are in conversation with each other by comparing the first sound signal X1 to the second sound signal X2. In one embodiment, communication and presence server 104 includes a speech recognition system operable to recognize a first headset user speech content and a second headset user speech content in the first sound signal X1, and recognize the first headset user speech content and the second headset user speech content in the second sound signal X2. The first headset user speech content and the second headset user speech are utilized in identifying the conversation between the first headset user and the second headset user. In a further embodiment, communication and presence server 104 includes a voice pattern recognition system operable to recognize a first headset user voice and recognize a second headset user voice utilizing stored voice patterns of the first headset user and the second headset user. Using the voice pattern recognition system, the communication and presence server 104 recognizes the first headset user's voice and the second headset user's voice in signal X1. The communication and presence server 104 also recognizes the second headset user's voice and the first headset user's voice in signal X2 to identify that the first headset user and the second headset user are in conversation with each other.

In one example location data associated with headset 40 and headset 60 is sent with sound signal X1 and sound signal X2, respectively, to communication and presence server 104. Headset 40 and headset 60 may gather location data with location services utilizing GPS, IEEE 802.11 network (WiFi), or cellular network data. For example, cellular or WiFi triangulation methods may be utilized. The location data is utilized by communication and presence server 104 to identify whether headset 40 and headset 60 are in close proximity to each other (e.g., co-located), which in turn is utilized as a factor in determining whether the user of headset 40 and the user of headset 60 are in conversation with each other.

Communication and presence server 104 is configured to store an updatable record of the detected conversation state (e.g., that a user of headset 40 is in conversation with the user of headset 60 face-to-face or when the headset 40 and headset 60 are being operated in sensor mode, and the identities of the user of headset 40 and user of headset 60). In one example, communication and presence server 104 transmits the updatable record of the detected conversation state to computing device 100 for storage and use by communication and presence application client 102 and to computing device 112 for storage and use by communication and presence application client 114, and reports this to other system users as well.

The communication and presence server 104 is operable to signal the communication and presence application client 102 on the computing device 100 that a communication (e.g., an IM or VoIP call) has been received from a remote communication device (e.g., a remote computer or mobile phone). The communication and presence application client 102 can respond to this signal in a number of ways, depending on which one of the detected conversation states the headset 40 is in. In one example, the communication and presence server 104 uses the detected conversation state record to generate and report presence information of the user of headset 40 to other system users, for example to a user stationed at the remote communication device.

The communication and presence server 104 is operable to signal the communication and presence application client 114 on the computing device 112 that a communication (e.g., an IM or VoIP call) has been received from a remote communication device (e.g., a remote computer or mobile phone). The communication and presence application client 114 can respond to this signal in a number of ways, depending on which one of the detected conversation states the headset 60 is in. In one example, the communication and presence server 104 uses the detected conversation state record to generate and report presence information of the user of headset 60 to other system users, for example to a user stationed at the remote communication device.

FIG. 5 an example conversation scenario in which the conversation detection system shown in FIG. 10 is utilized. In the example shown in FIG. 5, a headset user 42 is wearing a headset 40. Headset user 42 is in conversation with a conversation participant 44, which in this scenario is a wearer of headset 60. Headset 40 detects sound 14, which in this scenario includes speech 46 from headset user 42 and speech 48 from conversation participant 44. The headset 40 utilizing conversation module 62 determines that headset user 42 is currently participating in a conversation.

Headset 60 also detects sound 14, which in this scenario includes speech 46 from headset user 42 and speech 48 from conversation participant 44. The headset 60 utilizing conversation module 110 determines that conversation participant 44 is currently participating in a conversation. A conversation participant identity determination system 28 determines that headset user 42 wearing headset 40 is in conversation with conversation participant 44 wearing headset 60.

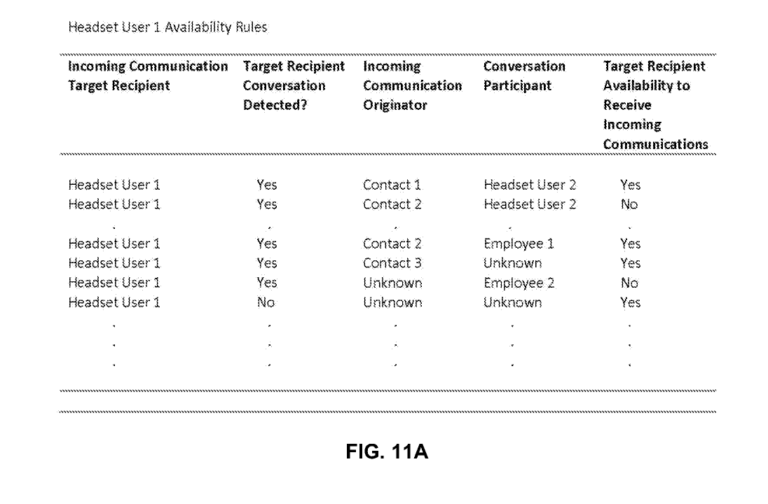

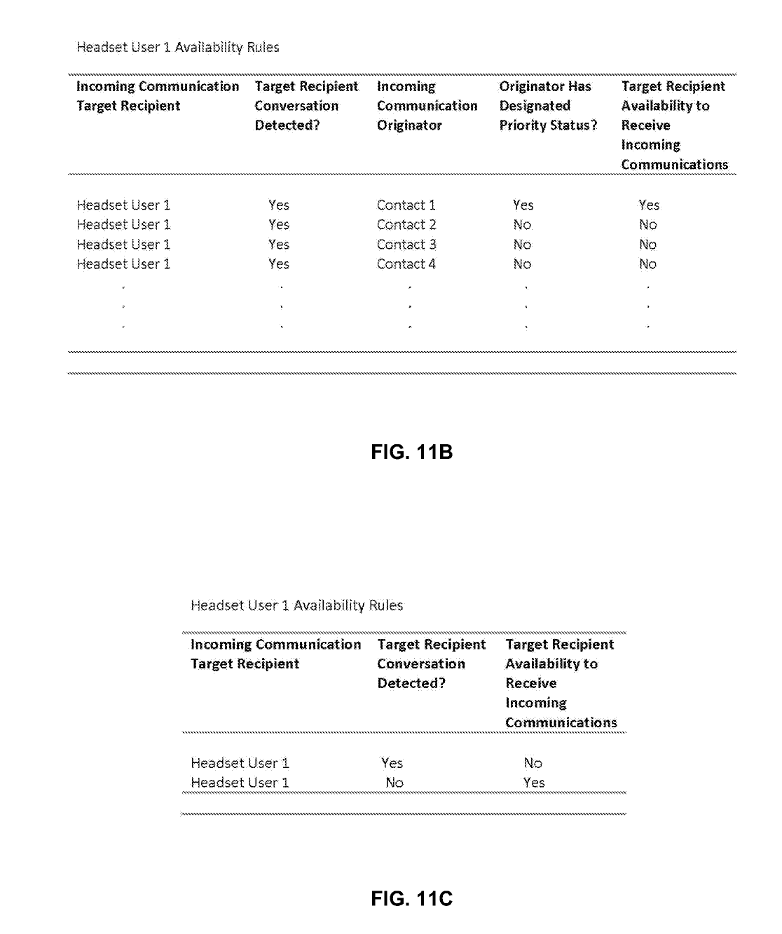

FIGS. 3-5 discussed above illustrate sample conversation states which may be detected. These sample conversation states are for illustration only, and are not exhaustive. FIGS. 11A-11C are tables illustrating availability rules which may be utilized by communication and presence server 78 and communication and presence application client 76 to determine a headset 40 user's availability (e.g., headset user 1) to receive incoming communications from remote user communication device 82 based on the detected conversation states. These rules are for example illustration only, as other configurations based on user preferences or organizational preferences will vary. Advantageously, a user can configure the circumstances under whether and how incoming messages are received based on these rules. As a result, the user need not turn off their devices when in a meeting or other situation where they do not wish to be disturbed by most people trying to contact them. Rather, the user can keep their devices active since they will only be interrupted by select incoming communications. This prevents the user from missing important incoming communications in their desire to not be interrupted by unimportant communications.

FIG. 11A is a table illustrating availability rules in one example for determining a headset user availability to receive incoming communications based on conversation detection. In the example shown in FIG. 11A, the availability rules for a headset user 1 are shown. Such a table may be generated for each registered headset user in the system. For each headset user, a detected conversation state record indicates whether the headset user is currently in a detected conversation and who the other conversation participant(s) are. Using this detected conversation state record and the identity of the incoming communication originator (e.g., obtained via caller identification), communication and presence server 78 and communication and presence application client 76 utilize the table of rules to determine the target recipient's (e.g., headset user 1) availability to receive the incoming communication. In the example shown in FIG. 11A, the target recipient's availability is based on whether the target recipient is in conversation, the identity of the conversation participant, and the identity of the originator of the incoming communication.

FIG. 11B is a table illustrating availability rules in a further example for determining a headset user availability to receive incoming communications based on conversation detection. In the example shown in FIG. 11B, the availability rules for a headset user 1 are shown. Such a table may be generated for each registered headset user in the system. For each headset user, a detected conversation state record indicates whether the headset user is currently in a detected conversation. In this example, the identity of the other participant in the conversation is not known or utilized. Using this detected conversation state record and the identity of the incoming communication originator (e.g., obtained via caller identification), communication and presence server 78 and communication and presence application client 76 utilize the table of rules to determine the target recipient's (e.g., headset user 1) availability to receive the incoming communication. In the example shown in FIG. 11B, the target recipient's availability is based on whether the target recipient is in conversation, the identity of the originator of the incoming communication, and whether the originator has a designated priority status. For example, the headset user's stored contacts (e.g., Microsoft Outlook contacts or Salesforce.com contacts) may designate that the originator of the incoming message has priority status for incoming communication availability purposes.

FIG. 11C is a table illustrating availability rules in one example for determining a headset user availability to receive incoming communications based on conversation detection. In the example shown in FIG. 11C, the availability rules for a headset user 1 are shown. Such a table may be generated for each registered headset user in the system. For each headset user, a detected conversation state record indicates whether the headset user is currently in a detected conversation. In this example, the identity of the other participant in the conversation is not known or utilized. Using this detected conversation state record, communication and presence server 78 and communication and presence application client 76 utilize the table of rules to determine the target recipient's (e.g., headset user 1) availability to receive the incoming communication. In this example, the identity of the originator of the incoming message is not utilized. In the example shown in FIG. 11C, the target recipient's availability is based on whether the target recipient is in conversation.

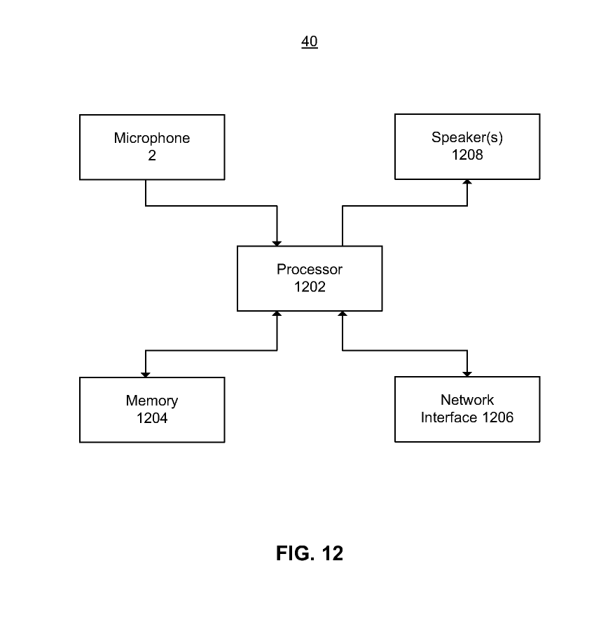

FIG. 12 illustrates a headset in one example configured to implement one or more of the examples described herein. Examples of headset 40 include telecommunications headsets. The term “headset” as used herein encompasses any head-worn device operable as described herein.

In one example, a headset 40 includes a microphone 2, speaker(s) 1208, a memory 1204, and a network interface 1206. Headset 40 includes a digital-to-analog converter (D/A) coupled to speaker(s) 1208 and an analog-to-digital converter (A/D) coupled to microphone 2. Microphone 2 detects sound and outputs a sound signal. In one example, the network interface 1206 is a wireless transceiver or a wired network interface. In one implementation, speaker(s) 1208 include a first speaker worn on the user left ear to output a left channel of a stereo signal and a second speaker worn on the user right ear to output a right channel of the stereo signal.

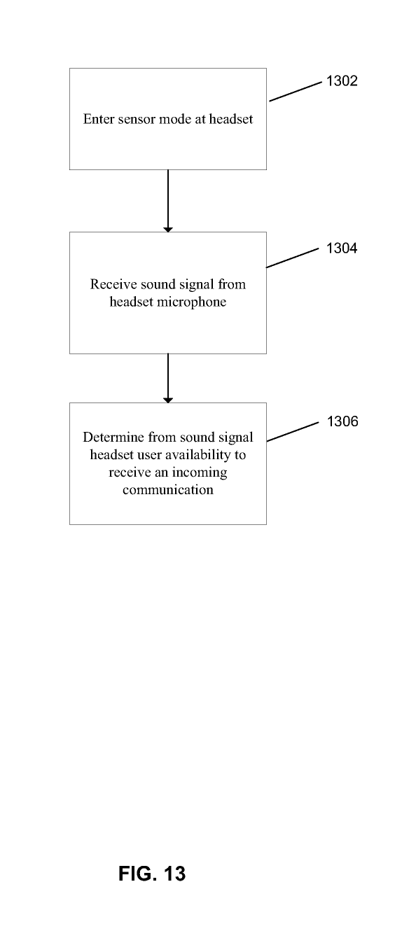

Memory 1204 represents an article that is computer readable. For example, memory 1204 may be any one or more of the following: random access memory (RAM), read only memory (ROM), flash memory, or any other type of article that includes a medium readable by processor 1202. Memory 1204 can store computer readable instructions for performing the execution of the various method embodiments of the present invention. In one example, the processor executable computer readable instructions are configured to perform part or all of a process such as that shown in FIGS. 13-15. Computer readable instructions may be loaded in memory 1204 for execution by processor 1202.

Network interface 1206 allows headset 40 to communicate with other devices. Network interface 1206 may include a wired connection or a wireless connection. Network interface 1206 may include, but is not limited to, a wireless transceiver, an integrated network interface, a radio frequency transmitter/receiver, a USB connection, or other interfaces for connecting headset 40 to a telecommunications network such as a Bluetooth network, cellular network, the PSTN, or an IP network.

In one example operation, the headset 40 includes a processor 1202 configured to execute one or more applications and operate the headset in a sensor mode to process the sound signal and identify a headset user participation in a conversation, wherein during the sensor mode the microphone is enabled to detect sound independent of whether the headset is participating in a telecommunications call. In one example, the processor 1202 is configured to operate the speaker in a standby (i.e., low power) or powered off state during the sensor mode.

In one example, the processor 1202 is configured to process the sound signal by recognizing a user speech in the sound signal. In one example, the processor 1202 is configured to process the sound signal and identify a headset user participation in a conversation by determining a sound level from the sound signal indicating the headset is being worn by the user and the headset user is speaking.

In one example, the processor 1202 is further configured to determine from the conversation a headset user availability to receive an incoming communication. In one example, the processor 1202 is further configured to determine an identity of a party participating in the conversation with the headset user and based on this identity determine a headset user availability to receive an incoming communication.

In one example operation, the processor 1202 is configured to execute one or more applications and operate the headset in a sensor mode to process the sound signal and identify a headset user state from the sound signal. In one example, the headset user state is an emergency state. In one example, the emergency state is identified by recognizing a spoken emergency word in the sound signal utilizing a speech recognition module. For example, the spoken emergency word may be “help”. In one example, the emergency state is identified by recognizing a sound pattern associated with an emergency in the sound signal. For example, the sound pattern may correspond to a sound indicative that the user is having a heart attack or is in pain. Sound patterns corresponding to emergency states may be stored in memory 1204. In one example, identification that the user is currently in an emergency state triggers an automatic request for assistance to an emergency responder. In a further example, identifying the headset user state from the sound signal comprises determining whether the headset user is a participant in a conversation. In one example, the method further includes determining from the headset user state a headset user availability to receive an incoming communication.

FIG. 13 is a flow diagram illustrating a method for conversation detection at a headset to determine a headset user availability to receive an incoming communication in one example. At block 1302, a sensor mode is entered at a headset. In one example, during the sensor mode a headset microphone is enabled to receive sound independent of whether the headset is participating in voice communications. At block 1304, a sound signal is received from the headset microphone while the headset is in the sensor mode.

At block 1306, it is determined whether the headset user is available to receive a current or future incoming communication. For example, the communication may be a text based message or an incoming voice call or communication. In one example, the headset user availability is based on whether a conversation has been identified from the sound signal and whether the headset user is a participant in the conversation. In one example, determining whether the headset user is a participant in the conversation includes determining a sound level from the sound signal indicating the headset is being worn by the user and the headset user is speaking.

In one example, the process further includes determining an identity of a second participant in the conversation, where the identity of the second participant is utilized in determining from the conversation the headset user availability to receive an incoming communication.

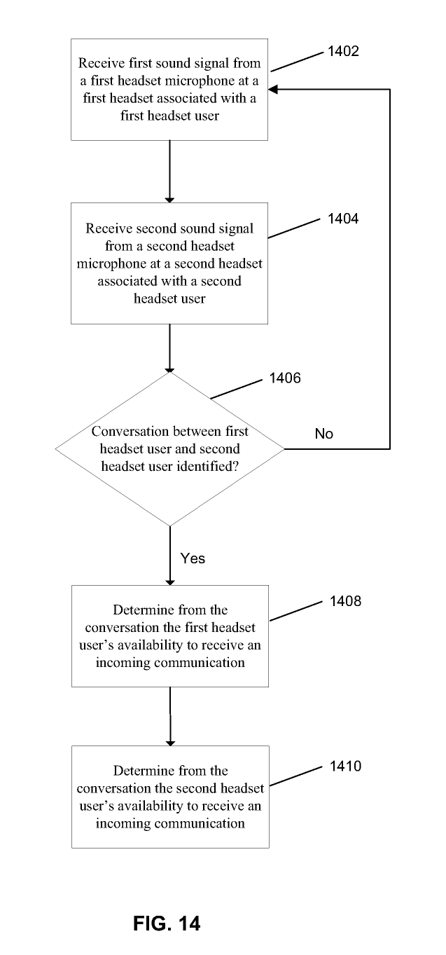

FIG. 14 is a flow diagram illustrating a method for conversation detection at a headset to determine a headset user availability to receive an incoming communication in one example. At block 1402, a first sound signal from a first headset microphone is received while a first headset associated with a first headset user is operating in a sensor mode. In one example, during the sensor mode the first headset microphone is enabled to receive sound independent of whether the first headset is participating in a telecommunications call.

At block 1404, a second sound signal from a second headset microphone is received while a second headset associated with a second headset user is operating in a sensor mode. In one example, during the sensor mode the second headset microphone is enabled to receive sound independent of whether the second headset is participating in a telecommunications call.

At decision block 1406, it is determined whether a conversation between the first headset user and the second headset user has been identified. In one example, identifying a conversation between the first headset user and the second headset user from the first sound signal and the second sound signal includes comparing the first sound signal to the second sound signal. In one example, the process further includes recognizing a first headset user speech content and a second headset user speech content in the first sound signal and recognizing the first headset user speech content and the second headset user speech content in the second sound signal. The first headset user speech content and the second headset user speech are utilized in identifying the conversation between the first headset user and the second headset user. In one example, the process further includes recognizing a first headset user voice and recognizing a second headset user voice from the first sound signal or the second sound signal. If no at decision block 1406, the process returns to block 1402.

If yes at decision block 1406, at block 1408 it is determined from the conversation the first headset user's availability to receive an incoming communication. In one example, the first headset user availability to receive an incoming communication is dependent upon an identity of the second headset user.

At decision block 1410, it is determined from the conversation the second headset user's availability to receive an incoming communication. In one example, the second headset user's availability to receive an incoming communication is dependent upon an identity of the first headset user.

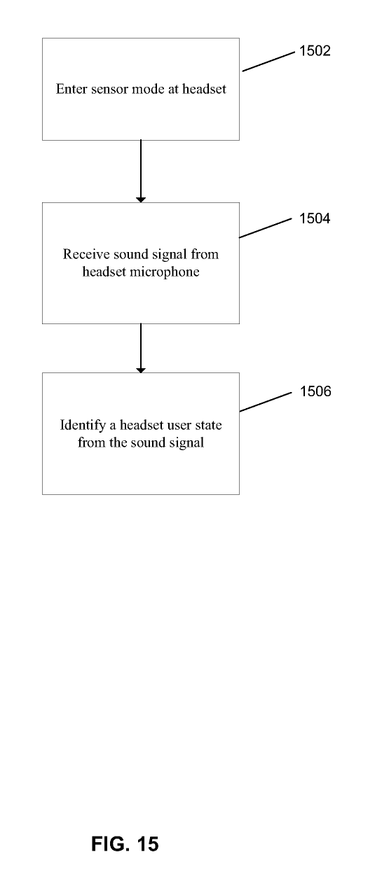

FIG. 15 is a flow diagram illustrating a method for determining a user status in one example. At block 1502, a sensor mode at a headset is entered. For example, during the sensor mode a headset microphone is enabled to receive sound to determine a headset user state. For example, during the sensor mode the headset is not being used on a call. At block 1504, a sound signal is received from the headset microphone while the headset is in the sensor mode.

At block 1506, a headset user state is identified from the sound signal. In one example, identifying the headset user state from the sound signal comprises determining whether the headset user is a participant in a conversation. In one example, the method further includes determining from the headset user state a headset user availability to receive an incoming communication.

In one example, the headset user state is an emergency state. In one example, the emergency state is identified by recognizing a spoken emergency word in the sound signal. For example, the spoken emergency word may be “help”. In one example, the emergency state is identified by recognizing a sound pattern associated with an emergency in the sound signal. For example, the sound pattern may correspond to a sound indicative that the user is having a heart attack or is in pain. In one example, the method further includes automatically transmitting a request for assistance to an emergency responder or other party responsive to identification that the user is currently in an emergency state.

While the exemplary embodiments of the present invention are described and illustrated herein, it will be appreciated that they are merely illustrative and that modifications can be made to these embodiments without departing from the spirit and scope of the invention. Certain examples described utilize headsets which are particularly advantageous for the reasons described herein. In further examples, other devices, such as other body worn devices may be used in place of headsets, including wrist-worn devices. Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, “circuit”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this Description of Specific Embodiments as an embodiment of the invention.

What is claimed is:

1. A method comprising:
entering a sensor mode at a body worn device, wherein during the sensor mode a body worn device microphone is enabled to receive sound independent of whether the body worn device is participating in a telecommunications call;
receiving a sound signal from the body worn device microphone while the body worn device is in the sensor mode;
identifying a conversation from the sound signal; and
determining from the conversation a body worn device user availability to receive an incoming communication.

2. The method of claim 1, wherein determining from the conversation the body worn device user availability to receive the incoming communication comprises determining whether the body worn device user is a participant in the conversation.

3. The method of claim 2, wherein determining whether the body worn device user is a participant in the conversation comprises determining a sound level from the sound signal indicating the body worn device is being worn by the user and the body worn device user is speaking.

4. The method of claim 1, further comprising determining whether the body worn device user is a first participant in the conversation and determining an identity of a second participant in the conversation.

5. The method of claim 4, wherein the identity of the second participant is utilized in determining from the conversation the body worn device user availability to receive the incoming communication.

6. A method comprising:
entering a sensor mode at a body worn device, wherein during the sensor mode a body worn device microphone is enabled to receive sound to determine a body worn device user state;
receiving a sound signal from the body worn device microphone while the body worn device is in the sensor mode; and
identifying the body worn device user state from the sound signal.

7. The method of claim 6, wherein identifying the body worn device user state from the sound signal comprises determining whether a body worn device user is a participant in a conversation.

8. The method of claim 6, further comprising determining from the body worn device user state a body worn device user availability to receive an incoming communication.

9. The method of claim 6, wherein the body worn device user state is an emergency state.

10. The method of claim 9, wherein the emergency state is identified by recognizing a spoken emergency word in the sound signal.

11. The method of claim 9, wherein the emergency state is identified by recognizing a sound pattern associated with an emergency in the sound signal.

12. A headset comprising:
a processor;
a communications interface;
a speaker arranged to output audible sound to a headset wearer ear;
a microphone arranged to detect sound and output a sound signal; and
a memory storing an application executable by the processor configured to operate the headset in a sensor mode to process the sound signal and identify a headset user participation in a conversation, wherein during the sensor mode the microphone is enabled to detect sound independent of whether the headset is participating in a telecommunications call.

13. The headset of claim 12, wherein the application is further configured to determine from the conversation a headset user availability to receive an incoming communication.

14. The headset of claim 12, wherein the application is further configured to determine an identity of a party participating in the conversation with the headset user.

15. The headset of claim 14, wherein the application is further configured to determine from the identity of the party participating in the conversation a headset user availability to receive an incoming communication.

16. The headset of claim 12, wherein the application is configured to process the sound signal by recognizing a user speech in the sound signal.

17. The headset of claim 12, wherein the application is configured to process the sound signal and identify the headset user participation in the conversation by determining a sound level from the sound signal indicating the headset is being worn by the headset user and the headset user is speaking.

18. The headset of claim 12, wherein the application is configured to operate the speaker in a standby or powered off state during the sensor mode.

19. One or more non-transitory computer-readable storage media having computer-executable instructions stored thereon which, when executed by one or more computers, cause the one more computers to perform operations comprising:
receiving a sound signal from a body worn device microphone while a body worn device is in a sensor mode, wherein during the sensor mode the body worn device microphone is enabled to receive sound independent of whether the body worn device is participating in a telecommunications call;
identifying a conversation from the sound signal; and
determining from the conversation a body worn device user availability to receive an incoming communication.

20. The one or more non-transitory computer-readable storage media of claim 19, wherein determining from the conversation the body worn device user availability to receive the incoming communication comprises determining whether the body worn device user is a participant in the conversation.

21. The one or more non-transitory computer-readable storage media of claim 20, wherein determining whether the body worn device user is a participant in the conversation comprises determining a sound level from the sound signal indicating the body worn device is being worn by the user and the body worn device user is speaking.

22. The one or more non-transitory computer-readable storage media of claim 19, wherein the operations further comprise determining whether the body worn device user is a first participant in the conversation and determining an identity of a second participant in the conversation.

23. The one or more non-transitory computer-readable storage media of claim 22, wherein the identity of the second participant is utilized in determining from the conversation the body worn device user availability to receive the incoming communication.

24. One or more non-transitory computer-readable storage media having computer-executable instructions stored thereon which, when executed by one or more computers, cause the one more computers to perform operations comprising:
receiving a first sound signal from a first body worn device microphone at a first body worn device associated with a first body worn device user;
receiving a second sound signal from a second body worn device microphone at a second body worn device associated with a second body worn device user;
identifying a conversation between the first body worn device user and the second body worn device user from the first sound signal and the second sound signal; and
determining from the conversation a first body worn device user availability to receive an incoming communication.

25. The one or more non-transitory computer-readable storage media of claim 24, wherein the operations further comprise determining from the conversation a second body worn device user availability to receive an incoming communication

26. The one or more non-transitory computer-readable storage media of claim 24, wherein the first body worn device user availability to receive the incoming communication is dependent upon an identity of the second body worn device user.

27. The one or more non-transitory computer-readable storage media of claim 24, wherein identifying the conversation between the first body worn device user and the second body worn device user from the first sound signal and the second sound signal comprises comparing the first sound signal to the second sound signal.

28. The one or more non-transitory computer-readable storage media of claim 24, wherein the operations further comprise recognizing a first body worn device user speech content and a second body worn device user speech content in the first sound signal and recognizing the first body worn device user speech content and the second body worn device user speech content in the second sound signal.

29. The one or more non-transitory computer-readable storage media of claim 28, wherein the first body worn device user speech content and the second body worn device user speech content are utilized in identifying the conversation between the first body worn device user and the second body worn device user.

30. The one or more non-transitory computer-readable storage media of claim 24, wherein the operations further comprise recognizing a first body worn device user voice and recognizing a second body worn device user voice from the first sound signal or the second sound signal.

31. The one or more non-transitory computer-readable storage media of claim 24, wherein the operations further comprise operating the first body worn device in a first body worn device sensor mode and operating the second body worn device in a second body worn device sensor mode.

32. The one or more non-transitory computer-readable storage media of claim 24, wherein the operations further comprise receiving a first location data associated with the first body worn device and receiving a second location data associated with the second body worn device, wherein the first location data and the second location data are utilized in identifying the conversation between the first body worn device user and the second body worn device user.

33. The one or more non-transitory computer-readable storage media of claim 24, wherein the operations further comprise receiving a first timestamp data associated with the first sound signal and receiving a second timestamp data associated with the second sound signal, wherein the first timestamp data and the second timestamp data are utilized in identifying the conversation between the first body worn device user and the second body worn device user.
